(19) United States
(12) Patent Application Publication
(10) Pub. No.: US 2013/0028483 A1
(43) Pub. Date: Jan. 31, 2013

(54) IMAGE EDITING PROGRAM, IMAGE EDITING METHOD, IMAGE EDITING APPARATUS AND STORAGE MEDIUM

(71) Applicants: Kanako Ohmatsu, Tokyo (JP); Takumi Kanasashi, Tokyo (JP)

(72) Inventors: Kanako Ohmatsu, Tokyo (JP); Takumi Kanasashi, Tokyo (JP)

(73) Assignee: SONY CORPORATION, Tokyo (JP)

(21) Appl. No.: 13/552,903

(22) Filed: Jul. 19, 2012

(30) Foreign Application Priority Data
Jul. 29, 2011 (JP) 2011-166243

(51) Int. Cl. G06K 9/00

(52) U.S. Cl. 382/106

(57) ABSTRACT

Provided is an image editing program that causes an arithmetic processing unit to execute setting a recognition target image from an image included in image data as well as setting attribute information of the recognition target image, searching a frame image for the recognition target image by using the attribute information with respect to each of frames constituting the image data, and assigning image processing information regarding a processing target region determined in accordance with an image range, within a frame, of the recognition target image retrieved in the step of searching.

### BACKGROUND

The present disclosure relates to an image editing program, an image editing method, an image editing apparatus and a storage medium, and relates to a technique of image editing to perform various kinds of image processing on image data such as video content.

Some video content such as a movie picture or a broadcast program is commercialized after performing image processing on a created piece of work.

For example, it is sometimes inappropriate to leave in a video picture a face of a particular person or display indicating personal information captured in video content. Further, there is an image inappropriate in one country though it is no problem for another country depending on a difference in the law, the custom, the religion or the like. For example, in the case where a country B applies video content created in a country A as a movie, as a sell-through video, as a broadcast program or the like, there may be a certain image in the content inappropriate to be shown publicly in the country B.

Accordingly, in commercialization of the video content, image editing is sometimes performed so that pixelization or blur processing on a predetermined image portion is performed to hide the image portion in the content.

### SUMMARY

Here, image processing such as an edition work for pixelization is assumed to be performed on a particular image in content. In this case, a position and a shape of the particular image continuously vary from frame to frame among frames that compose a moving image. That is, a position and a shape of a processing target region to be pixelized (pixel range on which pixelization is performed) vary from frame to frame.

Accordingly, it is necessary for an operator to specify and process the pixel region of the particular image for each frame and check each processed result in order to exactly hide the particular image thereby taking thousands of man-hours of the operator.

In view of the above-described problems, it is desirable to allow an operator to efficiently perform image editing work when performing image processing on a particular image appearing in image data, for example.

According to an embodiment of the present disclosure, there is provided an image editing program that causes an arithmetic processing unit to execute setting a recognition target image from an image included in image data as well as setting attribute information of the recognition target image, searching a frame image for the recognition target image by using the attribute information with respect to each of frames constituting the image data, and assigning image processing information regarding a processing target region determined in accordance with an image range, within a frame, of the recognition target image retrieved in the step of searching.

According to another embodiment of the present disclosure, there is provided a storage medium on which the above-described image editing program is recorded.

According to another embodiment of the present disclosure, there is provided an image editing method which includes setting a recognition target image from an image included in image data as well as setting attribute information of the recognition target image, searching a frame image for the recognition target image by using the attribute information with respect to each of frames constituting the image data, and assigning image processing information regarding a processing target region determined in accordance with an image range, within a frame, of the recognition target image retrieved in the step of searching.

According to another embodiment of the present disclosure, there is provided an image editing apparatus which includes a setting processing part setting a recognition target image from an image included in image data as well as setting attribute information of the recognition target image, a searching processing part searching a frame image for the recognition target image by using the attribute information with respect to each of frames constituting the image data, and an image processing setting part assigning image processing information regarding a processing target region determined in accordance with an image range, within a frame, of the recognition target image retrieved by the searching processing part.

According to the embodiments of the present disclosure described above, when a recognition target image is set, searching (tracking) is performed for the recognition target image in each frame by use of attribute information of the recognition target image. That is, a range (pixel range) in which the recognition target image appears in each frame is automatically detected. Subsequently, information for image processing such as pixelization is provided for a processing target region (pixel region on which image processing is performed) defined by the range of the retrieved recognition target image in each frame.

As described above, a bothersome operation such that an operator sets from frame to frame the pixel range on which image processing is to be performed and the operator performs the image processing can be avoided.

A technique of the present disclosure is advantageous to perform image processing such as pixelization efficiently and in a short time on a particular image in an edition work target video material such as moving image data of video content.

### BRIEF DESCRIPTION OF THE DRAWINGS

FIG. 1 is a block diagram illustrating an image editing apparatus of an embodiment of the present disclosure;

FIG. 2 is a diagram explanatory of a functional configuration example achieved by an image editing program of an embodiment;

FIG. 3 is a diagram explanatory of image editing work procedure of an embodiment;

FIG. 4 is a diagram explanatory of an image editorial operation of an embodiment;

FIG. 5 is a flowchart illustrating image editing processing of a first embodiment;

FIG. 6 is a flowchart illustrating recognition target image setting processing of the embodiment;

FIG. 7 is a diagram explanatory of an appearance example of a recognition target image in an image of the embodiment;

FIG. 8 is a diagram explanatory of image range information and image processing information for each track of the embodiment;

FIGS. 9A-9F are diagrams explanatory of an example of tracking and image processing of the recognition target image of the embodiment;

FIG. 10 is a diagram explanatory of tracking of a face image of the embodiment;

FIGS. 11A-11F are diagrams explanatory of an example of tracking and image processing of the recognition target image of the embodiment;

FIGS. 12A-12E are diagrams explanatory of correction processing of the embodiment;

FIG. 13 is a flowchart illustrating image editing processing of a second embodiment;

FIGS. 14A and 14B are diagrams explanatory of functional configuration examples achieved by an image editing program of an embodiment;

FIGS. 15A and 15B are flowcharts illustrating image editing processing of third and fourth embodiments; and

FIG. 16 is a diagram explanatory of a fifth embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The embodiments will be described in the following order.

<1. Program and Image Editing Apparatus>

<2. Image Editing Work Procedure>

<3. Image Editing Processing: First Embodiment>

<4. Image Editing Processing: Second Embodiment>

<5. Image Editing Processing: Third and Fourth Embodiments>

<6. Image Editing Processing: Fifth Embodiment>

<7. Modifications>

### 1. Program and Image Editing Apparatus

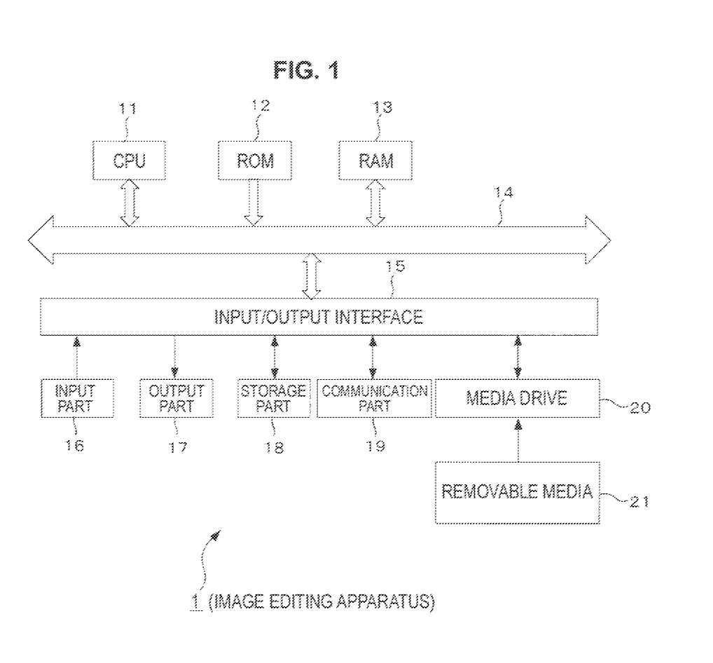

FIG. 1 is a block diagram illustrating an image editing apparatus of an embodiment. The configuration illustrated in FIG. 1 is a configuration example of a computer apparatus. The image editing apparatus of the embodiment is achieved by installing the image editing program of the present embodiment in such the computer apparatus, for example, and performing an operation based on the image editing program.

Of course, the image editing apparatus may be formed not by a general-purpose computer apparatus but by a computer apparatus dedicated to image editing and may be formed by an apparatus in which a functional operation based on the image editing program described below is performed by hardware.

In the embodiment, an example in which the image editing apparatus is achieved by a computer apparatus with the image editing program installed will be described.

In FIG. 1, an image editing apparatus 1 (computer apparatus) includes a CPU (Central Processing Unit) 11, a ROM (Read Only Memory) 12 and a RAM (Random Access Memory) 13.

The CPU 11 (arithmetic processing unit) performs various kinds of processing in accordance with a program stored in the ROM 12 or a program loaded from a storage part 18 to the RAM 13. Specifically, the CPU 11 performs various kinds of processing for an image editing work based on the image editing program.

In the RAM 13, data necessary for the CPU 11 to perform various kinds of processing is stored as appropriate.

The CPU 11, the ROM 12 and the RAM 13 are connected with one another via a bus 14. An input/output interface 15 is also connected to the bus 14.

To the input/output interface 15, an input part 16 and an output part 17 are connected as user interfaces.

The input part 16 includes a keyboard, a mouse and the like by which an operator performing the image editing work can perform input for various settings, an edition instruction and the like.

Alternatively, the input part 16 may include a digitizer or a fader by which the operator can perform an input operation. Or else, the input part 16 may include an interface with the digitizer or the fader as an external input unit.

The output part 17 includes a display such as LCD (Liquid Crystal Display), an organic EL (Electroluminescence) display or a CRT (Cathode Ray Tube) display, a speaker and the like. The output part 17 displays edition work target image data, an image after performing a various kinds of image processing, a screen for a correction operation or the like.

Further, the storage part 18, a communication part and a media drive 20 are connected to the input/output interface 15.

The storage part 18 is achieved by HDD (Hard Disk Drive), a flash memory or the like. The storage part 18 is used for storing various kinds of data and an application program. In the present embodiment, the storage part 18 may be used for storing the edition work target image data (video content and the like) or the image editing program.

The communication part 19 performs communication of data, a command, control information and the like with an external device. The communication part 19 may perform communication via a network such as the Internet or LAN (Local Area Network), or perform near field communication with wireless LAN, Bluetooth or the like. Alternatively, the communication part 19 may include a portion performing inter-device communication with a communication method such as USB (Universal Serial Bus). In any case, the communication part performs network communication or inter-device communication.

On the media drive 20, a removable media 21 such as a magnetic disk, an optical disk, a magnet optical disk or a semiconductor memory is loaded as appropriate and recording or reproduction is performed.

The image editing apparatus 1 of the present embodiment can retrieve the edition work target image data such that the communication part 19 receives the edition work target image data from the external device or downloads the edition work target image data over the network. Alternatively, the removable media 21 can provide the image data and the image editing apparatus 1 can retrieve the image data by reproduction of the removable media 21 performed by the media drive 20.

Further, the image data (edited content) after completion of image editing performed by the image editing apparatus 1 can be supplied from the communication part 19 to the external device or uploaded to a server or the like on the network. Or the image data after completion of image editing can be recorded in the removable media 21 by the media drive 20 and offered to a customer by the removable media 21.

In the image editing apparatus 1, the CPU 11 performs various kinds of processing for image editing work described below by processing based on the image editing program.

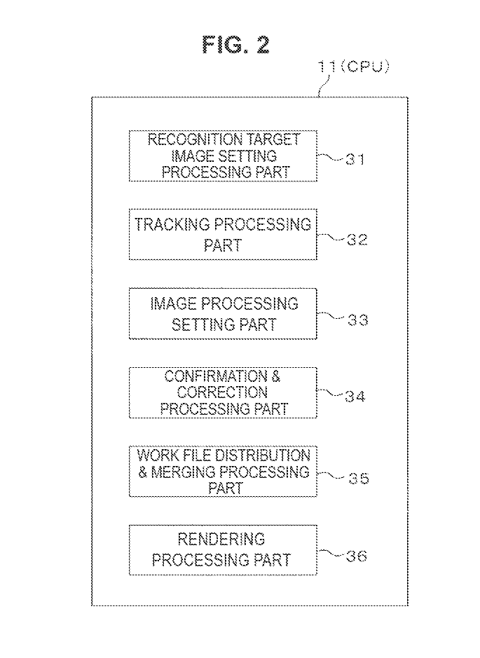

FIG. 2 illustrates a functional configuration of the CPU 11 achieved as the processing based on the image editing program.

As illustrated in FIG. 2, the CPU 11 includes a recognition target image setting processing part 31, a tracking processing part 32, an image processing setting part 33, a confirmation & correction processing part 34, a work file distribution & merging processing part 35 and a rendering processing part 36.

The recognition target image setting processing part 31 performs processing of setting a recognition target image in an image included in image data of an edition work target and setting attribute information of the recognition target image. Specifically, the recognition target image includes a particular face image, a particular object or an image in a range specified by an operator. The attribute information includes personal identification information or individual identification information for identifying an image of a particular person or a particular object. In addition, the attribute information includes tracking auxiliary information used for searching processing. Specifically, the tracking auxiliary information includes brightness information and color information included in the recognition target image.

The tracking processing part 32 performs processing for searching a frame image for the recognition target image by using the attribute information for each of frames constituting the image data. Specifically, the tracking processing part 32 searches each frame for a pixel range of the image set as the recognition target image. The searching processing of the recognition target image may also be called “tracking” for the sake of description.

The image processing setting part 33 attaches image processing information to a processing target region determined based on an image range of the retrieved recognition target image in a frame by the tracking processing part 32. The processing target region is assumed to be a pixel range of the recognition target image in the frame (that is, processing target region=pixel range of searched recognition target image), for example, but not limited to as will be described later as modifications.

The processing for attaching the image processing information is the processing for setting a type of certain image effect processing such as pixelization, blur or covering the eyes with a bar for the processing target region. Note that, as to pixelization, it is possible to set a plurality of types in pixelization size, and as to blur, it is possible to set a plurality of blur types depending on degree of blur.

When the image processing information is attached to the processing target region, attached image effect processing is performed finally on the processing target region.

The confirmation & correction processing part 34 performs processing for displaying the image under editing to an operator after the image processing information is attached to the processing target region in each frame, and processing for correcting the range (pixel range or frame range) of the processing target region, or for correcting the image processing information in response to input of the operator.

The work file distribution & merging processing part 35 performs processing for setting work files by time-sharing image data of the original edition material, or processing for setting work files for separately performing a distributed edition work for each recognition target image.

Further, the work file distribution & merging processing part 35 performs processing for merging work files of image editing works performed in a plurality of distributed systems.

The image editing apparatus 1 without a function as the work file distribution & merging processing part 35 may be available. It is because an edition work unaccompanied by work file distribution and merging processing may be considered. Or, though in the case where the work file distribution and merging processing is performed, the work file distribution may be performed in an external device and only the work file for performing the edition work in the image editing apparatus 1 may be input to the image editing apparatus 1. Or, the work files obtained by the edition work in the image editing apparatus 1 may be output to the external device for performing the merging processing in the external device.

Or, the image editing apparatus 1 may have either function of the distribution processing or the merging processing.

The rendering processing part 36 performs rendering processing. That is, the rendering processing part 36 creates edited image data reflecting the edition work as image data supplied to the outside.

In the case where rendering is performed in the external device, the image editing apparatus 1 may not include the rendering processing part 36.

The image editing apparatus 1 of the present embodiment performs various kinds of processing in the edition work described later in the case where the CPU 11 performs each of the processing illustrated in FIG. 2 as the functional configuration based on the installed image editing program.

Note that, though the CPU 11 mainly performs the processing in the image editing apparatus 1 of the present embodiment for sake of description, the apparatus may include an image processor or the like performing the image editing processing independent of the CPU 11. In such case, the image processor or the like may be provided with the functions illustrated in FIG. 2.

That is, the image editing program of the present embodiment is the program causing the arithmetic processing unit such as the CPU 11 to perform each of processing of the functional configuration illustrated in FIG. 2.

Note that, such image editing program may be preliminarily recorded in HDD as a storage medium incorporated in a device such as a personal computer, or ROM, a flash memory and the like in a microcomputer having CPU.

Alternatively, the image editing program may be temporarily or permanently stored (recorded) in a removable storage medium such as a flexible disk, CD-ROM (Compact Disc Read Only Memory), MO (Magnet Optical) disc, DVD (Digital Versatile Disc), Blue-ray Disc (registered trademark), a magnetic disc, a semiconductor memory and a memory card. Such removable storage medium may be supplied as a so-called software package.

Or, the image editing program may be downloaded from a download site via a network such as LAN (Local Area Network) or the Internet besides being installed from the removable storage medium to the personal computer or the like.

The above-described various kinds of removable storage media recorded with the image editing program, and the storage medium fixedly installed in a device such as HDD, ROM and a flash memory are corresponding to the storage medium according to the embodiment of the present disclosure.

### 2. Image Editing Work Procedure

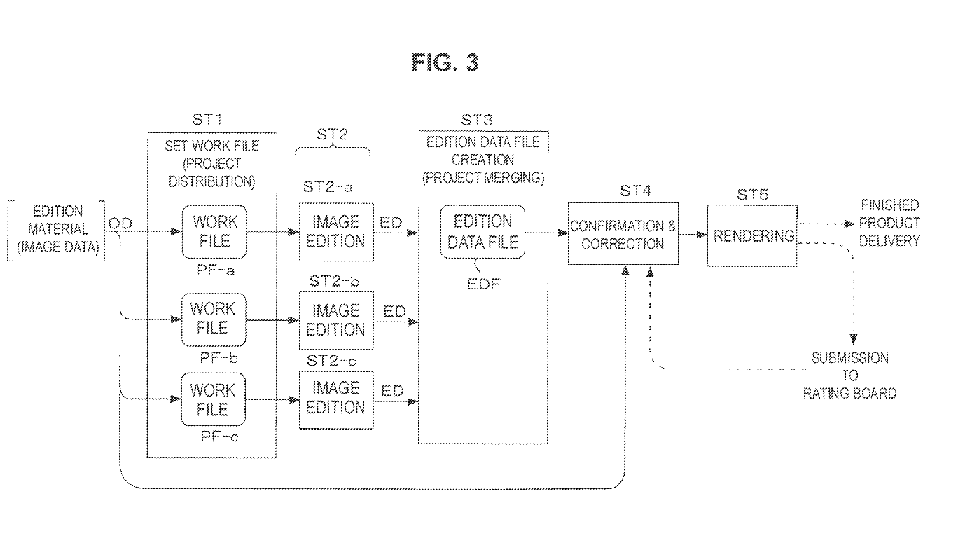

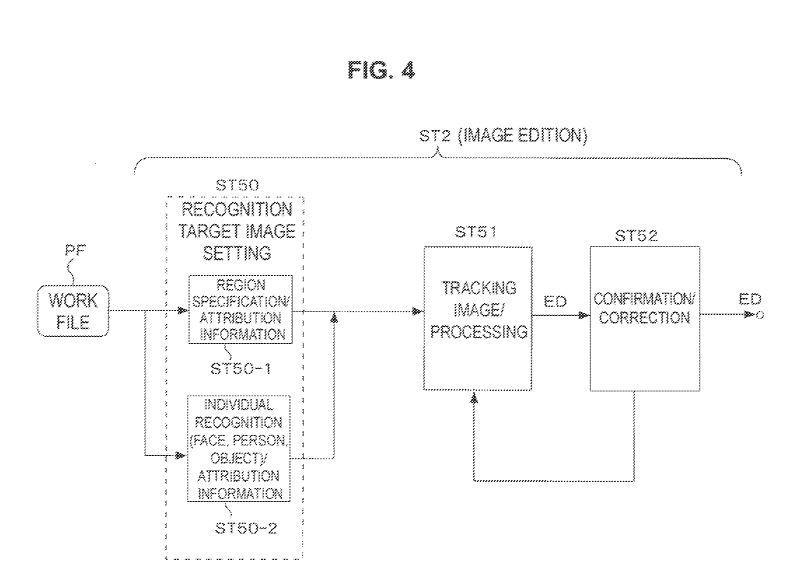

The image editing work procedure of video content according to the present embodiment will be described with reference to FIG. 3 and FIG. 4. Note that, the work procedure described below may be performed by a single image editing apparatus 1 (image editing program) and may be performed by a plurality of distributed image editing apparatuses 1.

FIG. 3 illustrates procedure (processing steps) from a step of inputting image data OD of an edition material until completion of edited image data. Each processing step will be described.

### [Work File Setting Step ST1]

In a work file setting step ST1, a work file PF for performing an image editing work is set.

The work file PF may be set as a single work file PF that is image data (AVI of an edition material itself or a plurality of work files PF (PF-a, PF-b, PF-c) may be set like an illustrated example.

The plurality of work files PF-a, PF-b, Pf-c . . . may be, for example, the image data files obtained by dividing the input image data OD along a time axis. For example, the image data files are obtained by dividing the image data OD of 30 minutes video content into three pieces of 10 minutes image data. This corresponds to the case of project distribution, for example, where a plurality of operators take charge of video content each handling a divided part of the video content and performing an edition work.

As to project distribution, the case where a plurality of operators take charge of video content each handling an individual image processing target (for example, individual image content on which pixelization is performed) may be available. In this case, each of the plurality of work files PF-a, PF-b, PF-c . . . is the original image data OD.

Of course, the project distribution mixing the case of time-division and the case for each image processing target may be available.

In any case, the work file setting step ST1 is the step of setting an edition work target on which a certain operator performs edition by using the image editing apparatus 1 as a single work file PF, and setting of the work file PF may be determined depending on various conditions such as the size of video content, the number of operators, the number of image editing apparatuses and due date.

Note that, the setting of the work file PF can be performed on a certain image editing apparatus 1 having a work file setting function (for example, work file distribution & merging processing part 35 in FIG. 2), but in the case of setting a plurality of work files PF for project distribution, it may be unnecessary to perform the work file setting on another image editing apparatus 1 used by another operator. That is, it is only necessary for the other image editing apparatus 1 to enable input of a set work file but not indispensable to have the function of the work file distribution & merging processing part 35 of FIG. 2.

### [Image Editing Step ST2]

Subsequently, the image editing apparatus 1 performs image editing step ST2. The image editing step ST2 is a work based on functions of the recognition target image setting processing part 31, the tracking processing part 32, the image processing setting part 33 and the confirmation & correction processing part 34 of FIG. 2.

In FIG. 2 illustrates the image editing steps ST2-a, ST2-b and ST2-c for the set three work files PF-a, PF-b and PF-c, respectively. FIG. 2 illustrates an example in the case of project distribution. The image editing steps ST2-a, ST2-b and ST2-c may be performed by separate image editing apparatuses 1 (computer apparatuses and the like in each of which the image editing program is installed), respectively.

Of course, in the case where the image data of the edition material is directly set as one work file PF without the above-described project distribution, the image editing processing on the work file PF may be performed in one image editing apparatus 1.

FIG. 4 illustrates processing content of the image editing step ST2 performed in the image editing apparatus 1.

In the image editing step ST2, a recognition target image setting step ST50, a tracking & image processing step ST51 and a confirmation & correction step ST52 are performed.

The recognition target image setting step ST50 is the processing for determining a target image (recognition target image) for performing tracking for each frame of the image data of the work file and setting attribute information related to the recognition target image.

In the recognition target image setting step ST50, the recognition target image can be set in two kinds of methods. The two kinds of methods are setting processing (ST50-1) based on region specification by the operator and setting processing (ST50-2) based on automatic detection of an individual piece. Either or both of processing processes are performed in response to an instruction input of the operator.

At first, in the setting processing (ST50-1) based on the region specification by the operator, an image in the region is set as the recognition target image in response to the region specification input of the operator on a screen with displaying an image of a certain frame of the work file PF.

The operator inputs the region specification by specifying the region on the screen by a fixed shape such as a circle or a rectangle, or by an arbitrary shape traced by the operator on the screen or defined by multiple positions designated by the operator on the screen.

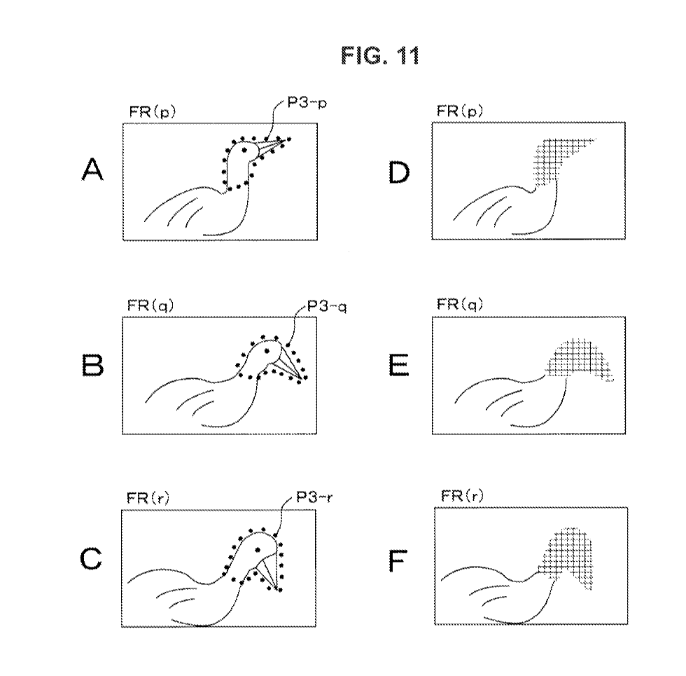

For example, in the case as illustrated in FIG. 11A which will be described later where the operator specifies positions to surround a bird head in a frame displaying an image of the bird, the region (image portion) of the bird head is to be set as the recognition target image.

Further, attribution information is set for the set recognition target image. The attribution information in this case is tracking auxiliary information used for tracking. For example, the tracking auxiliary information such as brightness information and color information of a pixel, color arrangement information or a pattern of the image content in the specified range, is stored in relation to the set recognition target image.

Next, in the setting processing (ST50-2) based on the automatic detection of the individual, the recognition target image is set depending on a result of face recognition or recognition of a particular individual piece performed based on image analysis processing on the image data in the work file.

For example, a face is detected by analyzing the image content. Then, the face image portion is set as the recognition target image. Not only a human face but also an animal face portion or a particular object recognized may be set as the recognition target image.

Further, attribution information is set for the set recognition target image. In this case, the content of the attribution information is individual piece (personal) identification information and the tracking auxiliary information.

The personal identification information is the information for identifying a face image or the like detected based on the image analysis processing, such as layout information or the like of eyes, a nose, a mouth added to the attribution information as face information of a particular person, and registered in relation to the recognition target image.

In the case where the personal identification information is not information of the face but of a particular object (construction, goods, a copyrighted work or the like having a particular shape such as signboard indicating a particular trademark, trade name or the like), an image pattern synthesizing the shape, the pattern, the color arrangement and the like of the particular object may serve as the individual piece identification information.

In addition to the individual piece (personal) identification information, the tracking auxiliary information such as brightness information and color information of a pixel, color arrangement information or a pattern of the image content in a region of the recognition target image is registered as the content of the attribution information related to the set recognition target image.

As described above, in the recognition target image setting step ST50, the recognition target image on which the tracking is desired to be performed is set in each frame by the operator input or automatic detection, and the attribution information (individual piece (personal) identification information and tracking auxiliary information) is recorded in relation to the set recognition target image.

Though described in detail later, the set recognition target image is handled as one “track” distinguished from another track by the attribution information.

Note that, also in the setting processing (ST50-1) based on the region specification by the operator, in the case where an image in a region that the operator specifies is a particular individual piece or a particular person, the individual piece identification information or the personal identification information may be added as the attribution information. For example, when an image is a person's face, layout information of eyes, a nose, and a mouth for identifying the person may be the personal identification information. When an image in a region specified by the operator is a particular object, an image pattern synthesizing the shape, the pattern, color arrangement and the like of the object may be the individual piece identification information.

Subsequently, the tracking & image processing step ST51 is performed.

In the tracking & image processing step ST51, searching (tracking) for a pixel range equivalent of a recognition target image is performed in each of frames constituting the work file PF. Processing is performed for adding image processing information to a processing target region defined in accordance with an image range of the retrieved recognition target image in the frame. That is, the processing is the above-described processing performed by the tracking processing part 32 and the image processing setting part 33 of FIG. 2. Accordingly, edition data ED is created.

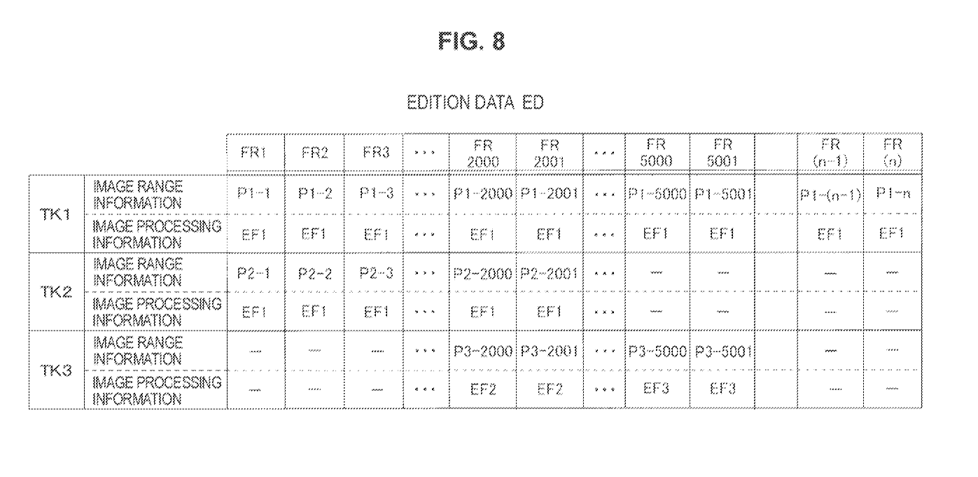

Though described in detail later, the edition data ED created in the tracking & image processing step ST51 is the data including image range information and image processing information in each frame of each recognition target image (track) as illustrated in FIG. 8, for example.

The image range information is the pixel range information as a processing target region in each frame on which image processing is performed. The processing target region is assumed to be a region of the recognition target image in each frame, for example.

Further, the image processing information is the information (type information of image processing) indicating what type of image effect processing is applied to the frame. For example, the image processing information is the information indicating the content of the image processing such as “pixelization 1”, “pixelization 2”, “pixelization 3”, “blur 1”, “blur 2” or “covering the eyes with a bar”. “Pixelization 1”, “pixelization 2” and “pixelization 3” are different in pixelization effect level (e.g., pixel size), for example. “Blur 1” and “blur 2” are different in blur effect level (degree), for example.

Of course, other types of processing other than the above-described processing such as soft focus, brightness reversal, monochromating, color change or the recently described processing different in effect levels may be performed and the image processing information in accordance with the type and the effect level of the processing is set.

Subsequently, the confirmation & correction step ST52 is performed in which the operator confirms and corrects manually the state after automation edit performed in the tracking & image processing step ST51.

That is, processing is performed for displaying the edited image, correcting the range (pixel range or frame range) of the processing target region or correcting the image processing information in accordance with input of the operator as processing performed by the confirmation & correction processing part 34 of FIG. 2. That is, specifically, the processing for correcting the edition data ED illustrated in FIG. 8 is performed.

If necessary, the tracking & image processing step ST51 may be performed again.

Further, track merging processing may be performed in the confirmation & correction step ST52.

Especially, in the case where face images or the like of the same person are recognized as of different persons due to accuracy of the attribution information in the above-described automatic detection & setting processing step and separate tracks are created, or in the case where a track additionally created by additional specification of a region on a recognition target image and another track move in the same way, the separate tracks or the previously created track and the additionally created track may be merged.

Owing to the merging processing, a track for each person can be correctly created or processing target images can be merged in one track.

After performing the above-described confirmation & correction step ST52, the image editing step ST2 is terminated.

### [Edition Data File Creation Step ST3]

Referring to FIG. 3 again, the edition data ED for the work file PF is obtained by performing the above-described image editing step ST2.

The edition data file creation step ST3 performed by a function of the work file distribution & merging processing part 35 is processing for merging pieces of the edition data ED created in the image editing steps ST2-a, ST2-b, ST2-c . . . performed in project distribution to create a merged edition data file EDF.

Note that, in the case where the above-described work file setting step ST1 is not a step for the project distribution and only one division of the image editing step ST2 is performed, the content of the edition data obtained by the image editing step ST2 may directly become the edition data file EDF.

The edition data file EDF is the file merging necessary pieces of edition processing information of all pieces of image data OD of the edition material.

### [Confirmation & Correction Step ST4]

In the confirmation & correction step ST4, confirmation and necessary correction of image editing is performed on all pieces of the image data OD by a function of the confirmation & correction processing part 34 of FIG. 2.

The confirmation & correction step ST52 in the above-described image editing step ST2 is confirmation and correction of the edition data ED for each work file PF based on the work file PF and the edition data ED. But the confirmation & correction step ST4 performs confirmation for all of the pieces of original image data OD and for each merged edition data file EDF, and correction of the edition data ED.

### [Rendering Step ST5]

When the confirmation & correction step ST4 results in OK, rendering is performed by a function of the rendering processing part 36 and content as edited image data is created. Image data on which rendering is performed is the image data on which image processing specified for the image range of each frame indicated in the edition data file EDF with respect to the image data OD of the edition material is performed.

The edited content is submitted to a rating board of video content and screening or sales is approved. However, in some cases correction (work in the confirmation & correction step ST4) is performed again in accordance with instructions of the rating board.

After being approved, the edited content can be delivered as finished products of video content.

Step ST1 through step ST5 in the procedure of the edition work described above can be totally performed by one image editing apparatus 1 or can be performed by a plurality of image editing apparatuses 1.

The image editing apparatus 1 of the present embodiments can perform at least the processing in the image editing step ST2.

### 3. Image Editing Processing

### First Embodiment

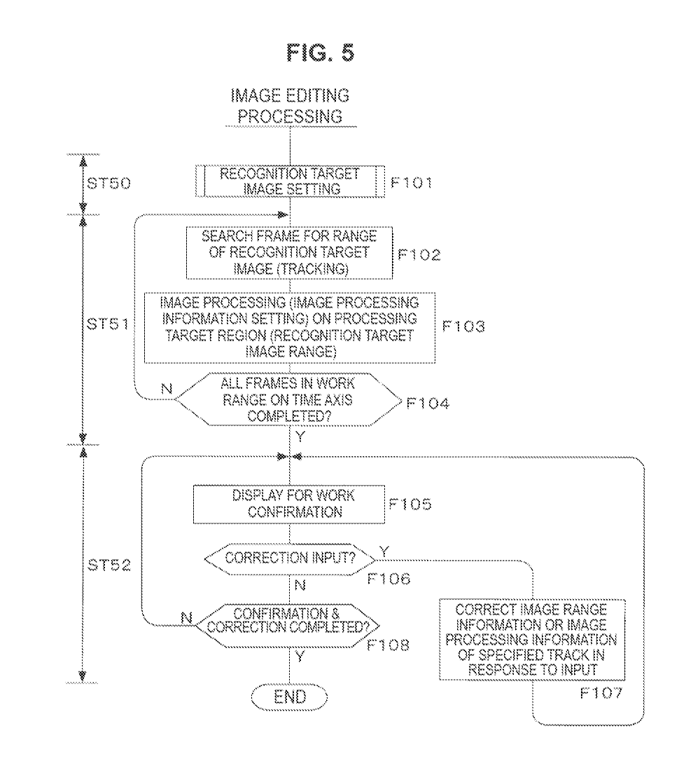

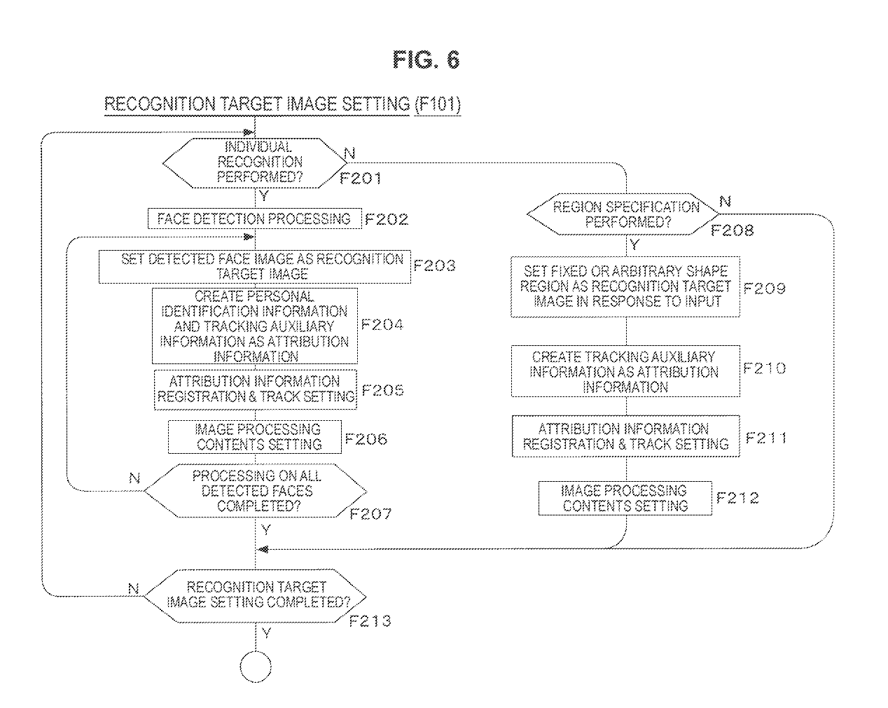

A specific processing example (first embodiment) of the image editing step ST2 performed by the image editing apparatus 1 illustrated in FIG. 4 will be described with reference to FIG. 5 and FIG. 6.

FIG. 5 illustrates processing performed by the CPU 11 having functions illustrated in FIG. 2.

Note that, the recognition target image setting step ST50 in FIG. 4 corresponds to step F101 in FIG. 5, the tracking & image processing step ST51 corresponds to steps F102-F104 and the confirmation & correction step ST52 corresponds to steps F105-F108.

First, the CPU 11 performs setting processing of the recognition target image in step F101.

The processing in step F101 will be described in detail with reference to FIG. 6.

As described in FIG. 4, in the recognition target image setting step ST50, one or both of the setting processing (ST50-1) based on region specification by the operator and the setting processing (ST50-2) based on automatic detection of an individual piece are performed.

The CPU 11 monitors the input of the operator in input monitoring processing of steps F201-4 F208-4 F213 illustrated in FIG. 6 and the CPU 11 proceeds with the processing step in accordance with the input.

Step F201 is the monitoring processing of instruction input of the setting processing based on an automatic detection of an individual piece.

Step F208 is the monitoring processing of instruction input of the region specification.

Step F213 is the monitoring processing of an exit operation of the recognition target image setting.

In the case where the operator inputs an instruction for the setting processing (ST50-2) based on automatic detection of an individual piece, the CPU 11 proceeds from step F201 to step F202. Here, detection of a face in the image is described as an example of the automatic detection.

In step F202, the CPU 11 performs image analysis on one frame or a plurality of frames in the work file PF to detect a face image of a person appearing in the image. For example, the CPU 11 determines existence of three elements such as eyes, a nose and a mouth in an image and detects one or a plurality of face images.

When detecting one or a plurality of face images, the CPU 11 performs the setting processing on each detected face image in steps F203-F207.

First, the CPU 11 sets one of the detected face images as the recognition target image in step F203.

Subsequently, the CPU 11 creates attribution information for the set face image in step F204. As described above, the CPU 11 creates the personal identification information and the tracking auxiliary information as the attribution information.

Subsequently, the CPU 11 registers the attribution information in relation to the recognition target image in step F205. Note that, one recognition target image is hereinafter handled as one “track”. The track corresponds to the image content distinguished from other image content by the attribution information. Accordingly, one track is set by registration of the attribution information in relation to the recognition target image.

Further, the CPU 11 sets image processing content for the track (recognition target image) in step F206, that is, the type of the image effect processing applied to the track. For example, the CPU 11 sets the image processing content such as “pixelization 1”. Specifically, the CPU 11 sets, in accordance with the input of the operator, what kind of image processing is to be performed on the recognition target image. For example, the CPU 11 causes the detected recognition target image to be presented on a screen of the output part 17, and the operator is asked to select the image processing content. The CPU 11 sets the image processing content such as “pixelization 1” in accordance with the input of the operator performed in response.

The processing in the above-described steps F203-F206 is performed for each of the detected face images. That is, the CPU 11 returns the processing to step F203 and repeatedly performs the processing in steps F203-F206 for the subsequent face image until determining in step F207 that the processing for all of the face images is terminated.

When the processing for all of the face images is terminated, the CPU 11 proceeds from step F207 to step F213. That is, the CPU 11 returns to the input monitoring processing of steps F201→F208→F213.

Note that, though the setting processing is described as the setting processing of the recognition target image based on face detection in the present embodiment, the processing in the steps F201-F207 can be performed even in the case of detecting a particular image (human body, particular object) other than the face image.

Note that, though the processing in steps F203-F206 is performed for each of all of the face images in the present embodiment, it does not necessarily have to be performed for all of the face images. For example, it may be possible to have a function of exclusion from the recognition target image based on the preset attribution information. The function is, for example, processing for not setting a face of a particular person detected based on the attribution information as the recognition target image, or processing for not setting a face image having an image size (the number of pixels in the face image region) smaller than a predetermined size as the recognition target image. Further, processing for presenting the face image detected in step F202 to the operator for allowing the operator to select the face image to be set as the recognition target image (or the face image not to be set as the recognition target image) may be available.

When the operator inputs an instruction for performing the setting processing (ST50-1) based on the region specification, the CPU 11 proceeds from step F208 to step F209.

In this case, the operator performs an input operation of region specification on the display screen. The CPU 11 sets a region of a fixed shape or of an arbitrary shape that the operator inputs as the recognition target image in step F209.

Subsequently, the CPU 11 creates the attribution information for the image of the specified region in step F210. As described above, the CPU 11 creates the tracking auxiliary information as the attribution information. Note that, in the case where the image of the specified region is a face or a particular object, individual (personal) identification information may be included in the attribution information.

Thereafter, the CPU 11 registers the attribution information in relation to the recognition target image in step F211. One track is set by registration of the attribution information in relation to the recognition target image.

Further, the CPU 11 sets the image processing content for the track (recognition target image) in step F212, that is, the type of the image effect processing applied to the track. For example, the CPU 11 sets the image processing content such as “pixelization 1”. Like in step F206, the CPU 11 sets the image processing content in accordance with the input of the operator.

Then, the processing step proceeds to step F213 to return to the input monitoring processing of steps F201→F208→F213.

One or both of the recognition target image setting based on the automatic individual detection and recognition target image setting based on the region specification is performed one or a plurality of times in accordance with the operation by the operator.

When determining that necessary recognition target image setting (track setting) is completed, the operator performs an input operation of setting completion of the recognition target image. In response to the input operation, the CPU 11 terminates the processing from step F213. That is, the CPU 11 terminates the processing in step F101 illustrated in FIG. 5.

Subsequently, the CPU 11 performs the tracking & image processing step ST51 including steps F102-F104 illustrated in FIG. 5.

The CPU 11 performs searching (tracking) for the recognition target image in a frame with respect to each frame of the work file PF in step F102. Further, the CPU 11 performs processing for adding the image processing information to the processing target region (here, defined as processing target region=pixel range of recognition target image) in step F103.

The CPU 11 repeats the processing steps until the processing steps on all of the frames in a working range on the time axis terminates in step F104.

There are assumed to be a first frame FR1 through a last frame FR(n) as frames constituting video image data of the work file PF, for example.

Assuming that a time axis range across the work file PF is a working range on the time axis, the CPU 11 performs the processing in steps F102, F103 for the first frame FR1 and subsequently performs the processing in steps F102, F103 for the second frame FR2. The CPU 11 repeats the processing steps until completing the processing steps for the last frame FR(n).

Note that, the working range on the time axis may be a partial range in the work file PF. In this case, the processing in steps F102, F103 may be repeated on a certain frame to another certain frame selected as the working range on the time axis.

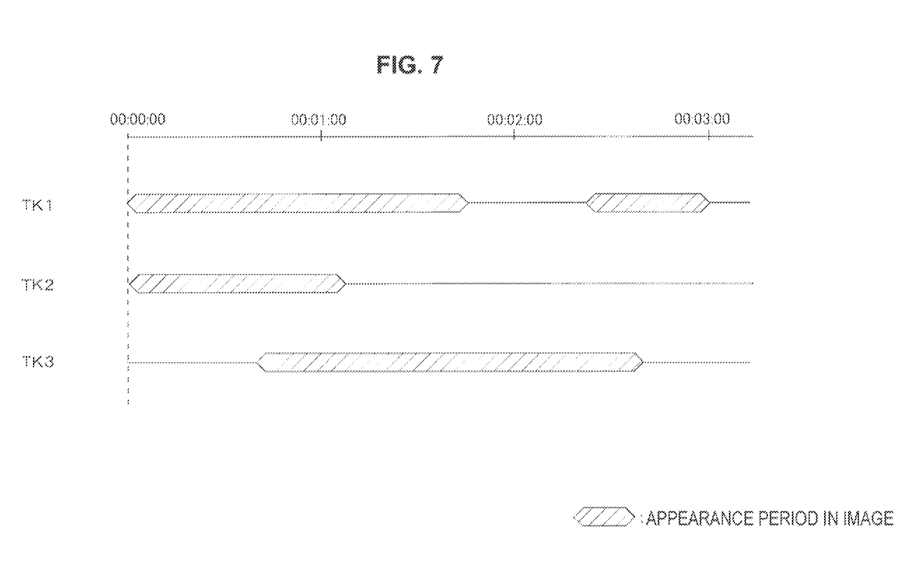

The processing of the tracking & image processing step ST51 performed in steps F102-F104 will be described with reference to FIG. 7 through FIG. 11.

Here, three images are assumed to be set as the recognition target images and three tracks TK1, TK2, TK3 are assumed to be set as illustrated in FIG. 7.

FIG. 7 illustrates a period during which the image of each track appears in the frame image on the time axis. For example, the tracks TK1, TK2 are assumed to be the face images set by the automatic face detection and the track TK3 is assumed to be an image of a certain object set by the region specification.

Each of the characters and the object appears and disappears depending on a story of a scene, a camera angle or the like of the video content. FIG. 7 illustrates such state of each track.

That is, in regard to each of the frames FR1-FR(n) of the video image data of the work file PF, all of the tracks do not necessarily appear in all of the frames.

The tracking processing is the processing for searching for whether each image set as the track exists in each frame based on the attribution information, and when exists, detecting the image range of the track.

Tracking is performed on each frame in step F102 as described above, and when the image corresponding to the track exists in the frame, processing for setting the image processing information is performed in step F103.

FIG. 8 illustrates an example of the edition data ED created by the processing in steps F102-F104.

For example, images of the tracks TK1, TK2 are assumed to exist in the frame FR1. In this case, the CPU 11 detects image range information P1-1 of the track TK1 in the frame FR1 by performing the tracking processing in step F102. Further, the CPU 11 detects image range information P2-1 of the track TK2.

Note that the image range information “Px-y” such as P1-1 is information representing the pixel range in a frame FRy with respect to a track TKx.

Further, in step F103, the CPU 11 sets image processing information EF1 attached to an image of the track TK1, that is, the pixel range in the frame FR1 represented as the image range information P1-1. The image processing information EF1 represents the image processing type such as “pixelization 1”. This is the image processing type information set for the track TK1 in the above-described step F206 (or F212) of FIG. 6.

Here, respective combinations of alphabets and a numeral represent respective processing types: EF1=“pixelization 1”, EF2=“pixelization 2”, EF3=“pixelization 3”, EF4=“blur 1”, EF5=“blur 2” and EF6=“covering the eyes with a bar”.

Similarly, the CPU 11 sets the image processing information (e.g., EF1) attached to an image of the track TK2, that is, the pixel range in the frame FR1 represented as the image range information P2-1.

After completing the processing on the frame FR1, the CPU 11 successively performs the processing in steps F102, F103 on the frame FR2. Similarly, the image range information and the image processing information are set on the successive frames in accordance with the appearing image of the track. When the processing to the frame FR (n) is completed, the edition data ED as illustrated in FIG. 8 is created.

For example, in the case where images of the tracks TK1, TK2, TK3 exist in the frame FR2000, respective image range information P1-2000, P2-2000, P3-2000 in the frame FR2000 and respective image processing information (for example, “EF1” “EF1” “EF2”) of the tracks TK1, TK2, TK3 are set.

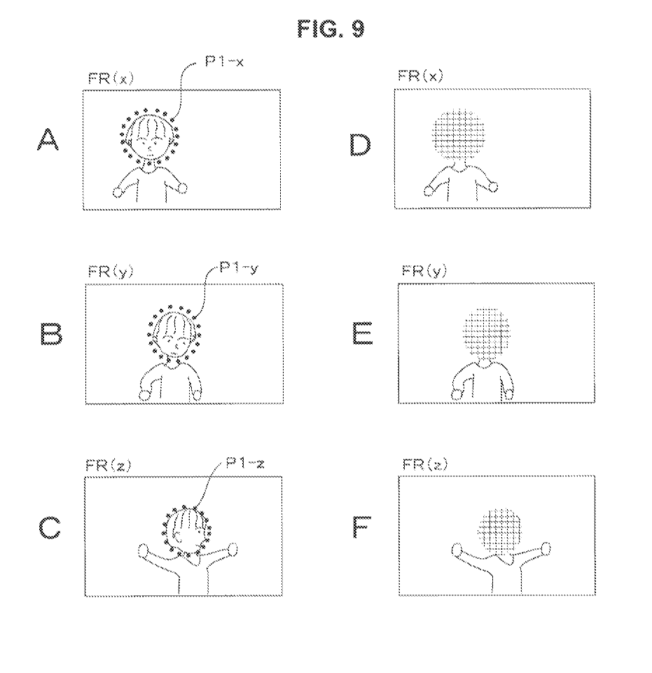

FIG. 9-FIG. 11 illustrate examples of tracking and setting of the image range information by tracking.

First, an example of the tracking processing on a face image will be described.

In the tracking processing related to each of the frames FR(x), FR(y) and FR(z) illustrated in FIG. 9A, FIG. 9B and FIG. 9C, respectively, face detection based on frame image analysis is performed first for each frame.

In the case of the frame FR(x) in FIG. 9A, a face image is detected and personal identification information (for example, layout information of eyes, nose and mouth) is created. Then, the personal identification information is compared with registered personal identification information for the tracks TK1, TK2, and whether the both of the personal identification information coincide with each other is determined. When the registered personal identification information coincides with the personal identification information of the track TK1, it is determined that the face image detected in the frame FR(x) is the face image of the track TK1 and a range of the face image as illustrated is set as the image range information P1-x of the track TK1 in the frame FR(x).

It is similar to the frame FR(y) illustrated in FIG. 9B. In this frame FR(y), in the case where the face image is detected and the detected personal identification information coincides with the registered personal identification information of the track TK1, it is determined that the face image detected in the frame FR(y) is the face image of the track TK1 and a range of the face image as illustrated is set as the image range information P1-y of the track TK1 in the frame FR(y).

In the case of the frame FR(z) illustrated in FIG. 9C, the face turns sideways. Accordingly, it may be difficult to detect the face image or create the personal identification information though detected. In such case, the face image is identified as the face image of the track TK1 by using the tracking auxiliary information and a range of the face image as illustrated is set as the image range information P1-z of the track TK1 in the frame FR(z).

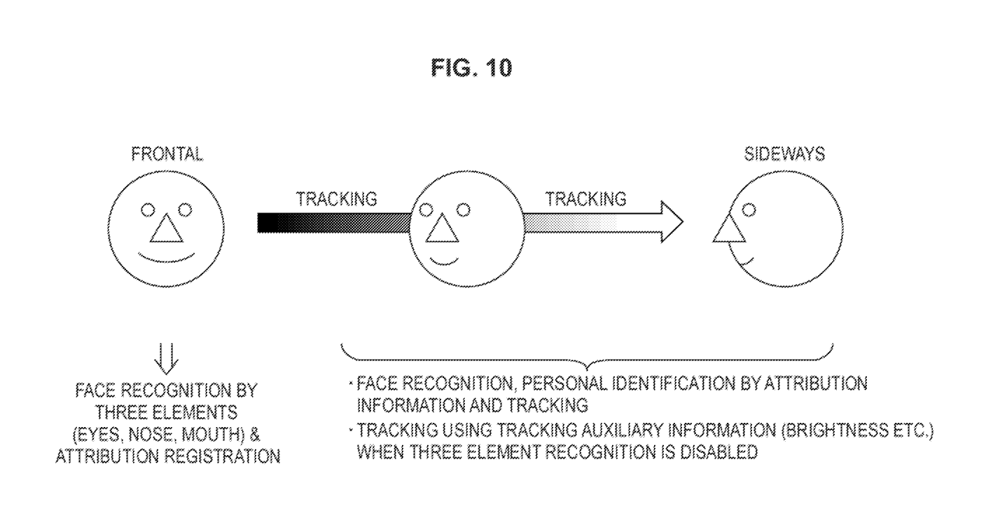

FIG. 10 illustrates a tracking method of the face image. Basically, face detection is performed by using the three elements such as eyes, a nose and a mouth as described above, both pieces of the personal identification information are compared and the face image corresponding to the recognition target image (track) is detected. In regard to a frame in a state where a face turns sideways to a certain degree, tracking may be performed to some extent, but a frame in a state where a face completely turns sideways, tracking may be difficult.

Accordingly, brightness information and color information are used as the tracking auxiliary information. In successive frames, the pixel range of a face image in a frame gradually moves or expands/reduces, so that it may be possible to determine the range having a brightness value and color information similar to a brightness value and color information of the previous frame as the face image of the same track.

Note that, a certain recognition target image sometimes appears again in a scene though disappeared once from the scene as illustrated in FIG. 7. For example, assuming that a face of a certain person A is the track TK1, the face image appears in the video image first and then disappears from the video image and appears again in the example illustrated in FIG. 7.

When tracking is referring to the personal identification information as described above, though in a frame period of the first appearance or in a frame period of the second appearance, tracking can be performed on the face of the person A as the track TK1 even in such case.

Next, an example of tracking for the track TK3 set by the region specification will be described.

An image region of a bird head as illustrated in FIG. 11A, FIG. 11B and FIG. 11C is assumed to be set as the recognition target image (track TK3).

In this case, brightness, color information, a color combination pattern, a shape pattern and the like are registered as the attribution information (tracking auxiliary information) for the recognition target image of the track TK 3. Tracking can be performed by recognizing that the image in the image region changing in shape in successive frames is the same as the image in the previous frame.

In regard to frames FR(p), FR(q), FR(r) illustrated in FIG. 11A, FIG. 11B and FIG. 11C, respectively, tracking can be performed on the image range as illustrated based on the tracking auxiliary information and the image range information P3-p, P3-q, P3-r of the track TK 3 are set for respective frames.

Note that, in regard to the track set by the region specification, in the case where information capable of individual (personal) identification is included in the attribution information, though appearing again after disappearing from the video image once, the recognition target image can be recognized as the same track.

As described above, the image processing information is set by performing the above-described processing in step F103 on the image range of each frame determined by tracking.

In the case where ED1 (e.g., “pixelization 1”) is set as the image processing information, the final edited image data (image data after performing the rendering step ST5) becomes the image data on which pixelization is performed as illustrated in FIG. 9D, FIG. 9E, FIG. 9F or image data on which pixelization is performed as illustrated in FIG. 11D, FIG. 11E, FIG. 11F.

The processing in steps F105-F108 as the confirmation & correction step ST52 will be described with reference to FIG. 5 again.

The CPU 11 performs automatic tracking and adds the image processing information in the work range on the time axis (the whole frame period of the work file or partial frame period specified by the operator) in the processing steps to step F104. The CPU 11 proceeds to step F105 after creating the edited data ED as illustrated in FIG. 8.

In step F105, the CPU 11 reflects edition content presented in the edition data ED to each frame of the original work file and presents the image under editing to the operator. That is, the CPU 11 creates an image on which the image processing such as pixelization indicated by the image processing information is performed on the pixel range of the image range information presented in the edition data ED for each of the frames (e.g., frames FR1-FR(n)). The CPU 11 causes the display device of the output part 17 to display the image under editing in frame-by-frame still images or in a moving image. The operator can confirm the images as illustrated in FIG. 9D, FIG. 9E, FIG. 9F, FIG. 11D, FIG. 11E and FIG. 11F frame by frame or confirm the moving image.

The operator confirms whether edition automatically performed is appropriate as the operator watches the image, and performs input for correction if necessary.

In the case where the operator performs the input for correction, the CPU 11 proceeds from step F106 to step F107 to perform processing for correcting the image range information or image processing information in the edition data ED in accordance with an instruction input of the operator.

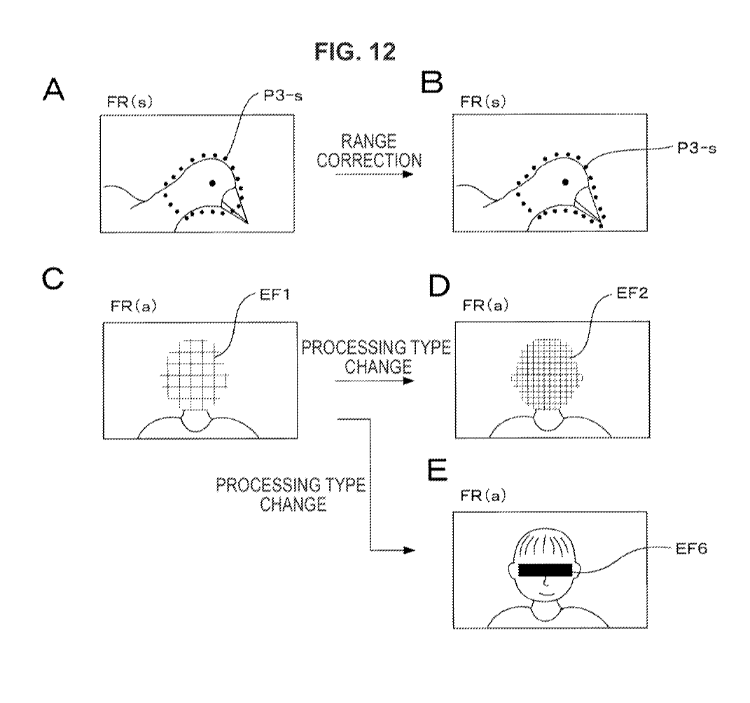

For example, image range information P3-s for a certain frame FR(s) is assumed to be a pixel range illustrated in FIG. 12A. Though not shown in FIG. 12A, when the pixelization or the like specified by the image editing information is performed on this pixel range, pixelization is not performed on the tip portion of the bird's beak. In such case, the operator performs the correction operation of the range to cause the CPU 11 to correct the content of the image range information P3-s. For example, the image range information P3-s can be corrected to the information representing a pixel range including the tip portion of the bird's beak as illustrated in FIG. 12B.

Alternatively, the image processing information for a certain frame FR(a) is assumed to be “EF1” specifying the processing of “pixelization 1” as illustrated in FIG. 12C. When the operator wants to change the type of image processing to another type, the operator performs a changing operation to other content (type) of image processing. The CPU 11 rewrites the image processing information for the frame FR(a) in accordance with the specified image processing type.

For example, in the case where the operator performs a changing operation to “EF2: pixelization 2”, the CPU 11 rewrites the image processing information for the frame FR(a) to “EF2”. Specifically, the image processing information is changed for specifying pixelization as illustrated in FIG. 12D.

Or, in the case where the operator performs a changing operation to “EF6: covering the eyes with a bar”, the CPU 11 rewrites the image processing information for the frame FR(a) to “EF6”. Specifically, the image processing information is changed for specifying the processing to cover the eyes with the bar as illustrated in FIG. 12E.

The CPU 11 corrects the image range information or the image processing information in the edition data ED in accordance with the input of the operator as described in the above examples.

The CPU 11 returns to step F105 after correcting the image range information or the image processing information to cause the display device of the output part 17 to display an image reflecting the correction content.

When the operator performs input for instructing termination of the confirmation and correction work when determining completion of the correction, the CPU 11 terminates the processing illustrated in FIG. 5 from step F108. That is, the image editing step ST2 in FIG. 3 is terminated. The edition data ED at this point is to be processed in the edition data file creation step ST3.

Here, a specific processing example of the processing in the confirmation & correction step in the above-described steps F105-F108 will be described.

Not only the correction work for each frame but batch correction or partial correction by track specification may be available as the correction work of the content of the edition data ED.

The correction work for each frame is performed such that the operator specifies a certain frame and performs a change of the image range information or the image processing information for the certain frame.

In the present embodiment, the recognition target image is managed as the track as described above. This management manner enables an efficient correction work.

For example, the image processing information of the track TK1 in all of the frames is assumed to be changed from “EF1: pixelization 1” illustrated in FIG. 8 to “EF4: blur 1”.

In this case, when the operator performs input in step F106, it is only necessary for the operator to perform operations for specifying the track TK1 and selecting “EF4: blur 1”. The CPU 11 updates the image processing information for the frames FR1-FR(n) of the track TK1 in the edition data ED illustrated in FIG. 8 from “EF1: pixelization 1” to “EF4: blur 1” in accordance with the operations of the operator.

Alternatively, the image processing information of the frames FR1-FR5 of the track TK1 is assumed to be changed from “EF1: pixelization 1” to “EF4: blur 1”.

In this case, when the operator performs input in step F106, it is only necessary for the operator to perform operations for specifying the track TK1 and the frames FR1-FR5, and selecting “EF4: blur 1”. The CPU 11 updates the image processing information for the frames FR1-FR5 of the track TK1 in the edition data ED illustrated in FIG. 8 from “EF1: pixelization 1” to “EF4: blur 1” in accordance with the operations of the operator.

Of course, the image processing may be excluded. For example, in the case where pixelization of the track TK1 is unnecessary, it is only necessary for the operator to specify the track TK1 and selecting “EF0: without image processing” when the operator performs input in step F106. The CPU 11 updates the image processing information for the frames FR1-FR(n) of the track TK1 in the edition data ED illustrated in FIG. 8 from “EF1: pixelization 1” to “EF0: without image processing” in accordance with the operations of the operator.

Of course, the operator may specify a part of frame period to be set as “EF0: without image processing” for temporarily excluding pixelization of the video image.

Note that, when setting the image processing content for the recognition target image in steps F206, F212 illustrated in FIG. 6, “EF0: without image processing” may be set.

The image range information can be corrected by using the track.

For example, the image range information is assumed to be corrected in the range of the frames FR50-FR60 of the track TK2.

The operator performs input operation for correcting the image range of the track TK2 in the frame FR50 and the image range of the track TK2 in the frame FR60 and instructs correction in the range from the frame FR50 to the frame FR60. In this case, the CPU 11 changes image ranges of the track TK2 in the frames FR51-FR59 based on brightness information and color information of the pixels in the range corrected in the frames FR50 and FR60. Then, the CPU 11 updates the image range information P2-50, P2-51 . . . P2-60 of the frames FR50-FR60.

Or, the CPU 11 may change the image ranges of the intermediate frames by performing interpolation based on shapes of the image ranges of both end frames. For example, the CPU 11 may estimate (perform interpolation for changing positions) variation in shapes of the image ranges of the track TK2 in the frames FR51-FR59 based on variation in shapes of the image ranges of the frames FR50, FR60 specified and changed by the operator, and update the image range information P2-50, P2-51 . . . P2-60.

Though the above-described processing is described as the processing performed in the confirmation & correction step ST52 in the image editing step ST2, similar correction by track unit may be performed in the confirmation & correction step ST4 illustrated in FIG. 3. It is because the edition data file EDF is the edition data ED itself or merging of a plurality of pieces of edition data ED created by the project distribution, and each recognition target image is managed in relation to the track.

The above-described image editing apparatus 1 (or image editing program) of the first embodiment has the following benefits.

Since the image processing on a particular image such as a person's face is performed almost automatically, it is only necessary for the operator to mainly perform confirmation and correction (fine adjustment) thereby enhancing efficiency and reducing working hours of the image editing work to a great extent.

Further, the correction work becomes easy because the recognition target image is managed in relation to the track. For example, in the case where it is desired not to perform on a face or the like of a particular person or it is desired to change the processing content of the face or the like of the particular person, since the recognition target image is managed in relation to the track based on the attribution information of the face, the image processing content of a plurality of frames can be changed collectively in response to the instruction for changing the image processing content by specification of the track.

Still further, in regard to correction of the image range of the processing target region, it is easy to change the shape of the range or to add or delete the region by using the management in relation to the track.

Still further, when the recognition target image such as signboard (sign) other than a person is specified, since tracking of the image can be performed, substantially automatic processing can be performed thereby achieving highly efficient edition work for various types of images.

Still further, it is easy to specify the recognition target image such as a face image by automatically detecting the recognition target image. Further, since the recognition target image can be set by the region specification, though the recognition target image has a complicated shape, the region in an arbitrary shape can be specified, and since tracking is performed based on the arbitrary shape, processing accuracy (accuracy of region on which processing is performed) is high. This brings benefits that correction of the shape and the position of the image range in the confirmation & correction steps ST4, ST52 is minimized.

Still further, the edition data ED and the edition data file EDF obtained as a result of the image processing work can be stored separately, so that merging and split are easy. Further, the content of the edition data ED and the edition data file EDF are reflected to the work file PF and the image data OD and the resultant is displayed for confirmation, so that rendering is unnecessary at the time of confirmation thereby achieving an efficient work.

Still further, efficient operation can be achieved because it is possible to merge pieces of image processing data (edition data ED) obtained by operations of a plurality of operators in project distribution.

### 4. Image Editing Processing

### Second Embodiment

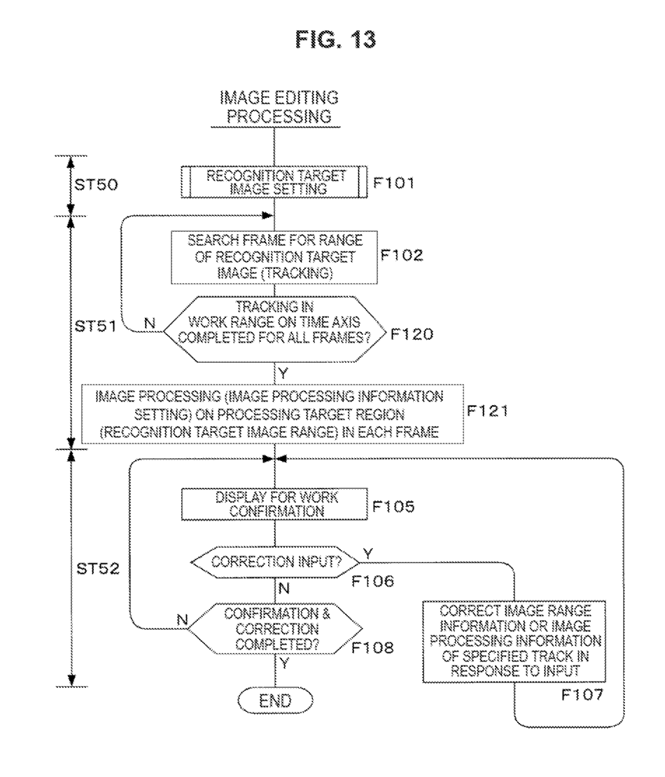

An example of processing of the second embodiment as the image editing processing (image editing step ST2) performed by the image editing apparatus 1 will be described with reference to FIG. 13.

Note that, processing steps in FIG. 13 similar to the above-described processing steps in FIG. 5 are denoted by the same step number and explanation thereof will be omitted. In FIG. 13, steps F102, F120, F121 corresponding to the tracking & image processing step ST51 illustrated in FIG. 4 are unlike the steps in FIG. 5 corresponding to the tracking & image processing step ST51.

The CPU 11 performs searching (tracking) for the recognition target image in a frame of the frames of the work file PF in step F102.

The processing performed in step F102 is repeated in step F120 until the processing in step F102 is performed on all of the frames in the work range on the time axis (that is, all of the frames in the work file PF, or the frames included in a period specified as the work range).

When tracking on all of the frames in the work range on the time axis is completed, the CPU 11 sets the image processing information corresponding to the image range information set by tracking for each frame in step F121.

Based on the above-described processing, the edition data ED is created and the processing is shifted to the processing of steps F105-F108 of the confirmation & correction step ST52.

That is, unlike the first embodiment in which the image range information is set by performing tracking for each frame and the image processing information is added at the same time, in the second embodiment, the image range information is set by performing tracking for all of the frames and the image processing information corresponding to tracks of each frame is set thereafter.

Though there may be various specific procedures for tracking or image processing setting, one of the procedures is the processing of the second embodiment described based on difference from the procedure illustrated in FIG. 5.

The second embodiment can produce effects similar to those produced by the first embodiment.

### 5. Image Editing Processing

### Third and Fourth Embodiments

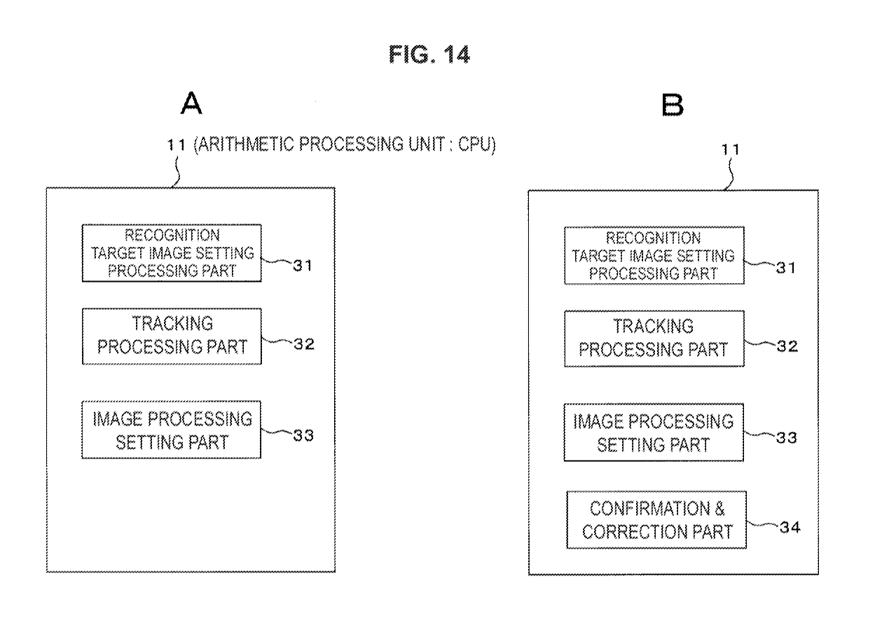

In the above description, the CPU 11 includes the functions illustrated in FIG. 2 achieved by the image editing program. The CPU 11 may include the recognition target image setting processing part 31, the tracking processing part 32 and the image processing setting part 33 illustrated in FIG. 14A as functions achieved by the image editing program.

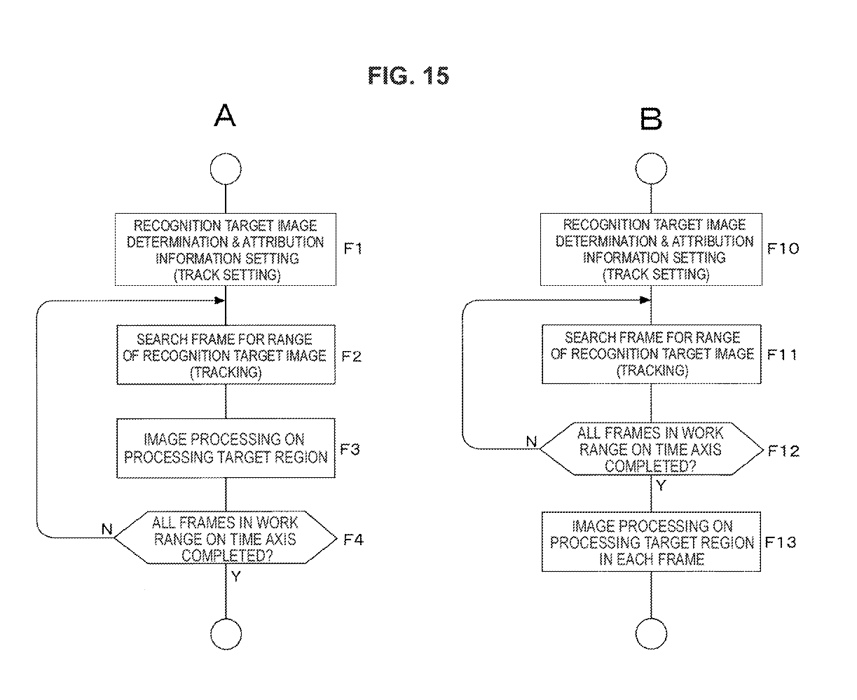

The CPU 11 can perform image processing (third embodiment) illustrated in FIG. 15A and processing (fourth embodiment) illustrated in FIG. 15B by including the functions illustrated in FIG. 14A.

In the processing of FIG. 15A, the CPU 11 performs determination of a recognition target image and setting of attribution information in step F1. The CPU 11 sets a track for the recognition target image.

The CPU 11 performs tracking of the recognition target image in a frame image in step F2. Further, the CPU 11 sets the image processing information for a processing target region determined in accordance with an image range of the recognition target image in step F3.

The CPU 11 repeats the above-described processing steps in step F4 until performance of the above-described processing steps on all of the frames in the work range on the time axis is completed, and terminates the image editing step ST2 when the above-described processing on all of the frames is completed.

That is, the image editing step ST2 includes only the recognition target image setting step ST50 and the tracking & image processing step ST51.

In the processing of FIG. 15B, the CPU 11 performs determination of a recognition target image and setting of attribution information in step F10. The CPU 11 sets a track for the recognition target image.

The CPU 11 performs tracking of the recognition target image in a frame image in step F11.

The CPU 11 repeats the above-described processing steps in step 12 until performance of the above-described processing steps on all of the frames in the work range on the time axis is completed, and proceeds to step F13 when the tracking on all of the frames is completed.

The CPU 11 sets the image processing information for a processing target region determined in accordance with an image range of the recognition target image for each frame in step F13. Then, the CPU 11 terminates the image editing step ST2.

In this embodiment, the image editing step ST2 includes only the recognition target image setting step ST50 and the tracking & image processing step ST51 illustrated in FIG. 4.

From these processing examples illustrated in FIG. 15A and FIG. 15B, the confirmation & correction step ST52 included in the above-described processing examples of FIG. 5 and FIG. 13 is omitted.

In such processing examples, efficiency of the edition work is improved by automatic tracking and addition of image processing information.

Note that, FIG. 14B illustrates a further another example of a functional configuration of the CPU 11 achieved by the image editing program. As illustrated in FIG. 14B, the CPU 11 includes a recognition target image setting processing part 31, a tracking processing part 32, an image processing setting part 33 and a confirmation & correction processing part 34.

The processing described with reference to FIG. 5 and FIG. 13 can be performed by such functional configuration.

The CPU 11 may include the functional configuration illustrated in FIG. 14B in the case where the CPU 11 performs processing steps in the image editing step ST2 described with reference to FIG. 3 and an external device and the like performs other steps.

### 6. Image Editing Processing

### Fifth Embodiment

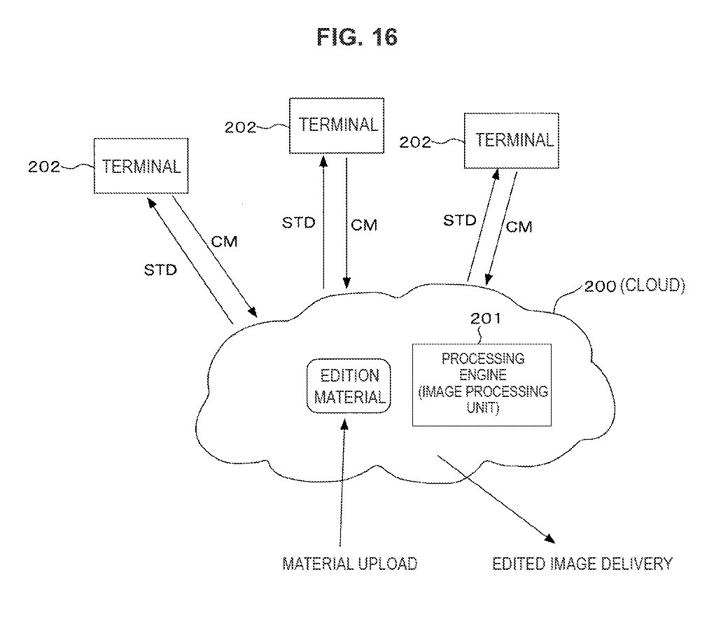

A fifth embodiment will be described with reference to FIG. 16. The embodiment is an example utilizing cloud computing.

As illustrated schematically in FIG. 16, a processing engine 201 is provided in a cloud 200 and image data as an edition material is uploaded.

The processing engine 201 includes an arithmetic processing unit which can detect input of a processing command supplied from an external terminal device via a wired or wireless transmission line and execute, in accordance with the input, processing of functions (recognition target image setting processing part 31, tracking processing part 32, image processing setting part 33 and confirmation & correction processing part 34) at least illustrated in FIG. 14A or FIG. 14B.

Each operator performs an edition work by using a terminal 202. The operator can confirm the content of the image when the image data of the edition material is distributed to the terminal 202 as streaming data STD.

Each operator transmits a processing command CM from the terminal 202 to the processing engine 201. That is, a processing command or the like as an input operation at the time of recognition target image setting, or as an input operation at the time of confirmation & correction is transmitted from the terminal 202. The processing engine 201 performs recognition target image setting, tracking, image processing setting and confirmation & correction processing related to the image data of the edition material in response to the processing command.

Such system allows the operator to perform an edition work by remote control or a distributed work easily at each terminal 202 on the edition material placed in the cloud 200 thereby significantly improving work efficiency as a whole.

### 7. Modifications

The embodiments are described above but there may be various modifications. The modifications are described below.

Though the recognition target image setting is described to be performed by automatic detection such as automatic face detection or the region specification by the operator, automatic setting by specification of a color may be available. For example, when the operator designates a particular color, an image of the corresponding color is set as the recognition target image. The specified color is not limited to monochrome but a particular pattern of multiple colors may be available.

The processing target region on which the image processing such as pixelization is performed is described as the image range of the recognition target image in the above embodiments. That is, processing such as pixelization is performed on the image itself set as the recognition target image. On the contrary, a portion other than the image set as the recognition target image may be the processing target region.

For example, though the range of the recognition target image in each frame is detected by setting a face of a certain person as a recognition target image (track) by the tracking processing, the image range information in the edition data ED is information indicating a range other than the range of the recognition target image. Or the image range information is positioned as information indicating a range other than the processing target region. Accordingly, the processing target region on which pixelization is performed is a portion other than the face of the particular person.

It is preferred in the case where a face other than the face of the particular person in the video content is not wanted to be seen, for example.

The processing content of the image processing may include pixelization, blur, covering the eyes with a bar, soft focus, brightness reversal, monochromating, color change and others. For example, the processing content of the image processing may include processing for replacing the image of the processing target region with another image such as an animation picture, decreasing brightness, painterly imaging or sepia toning.

Further, the technique of the present disclosure is described as an example applied to edition of the video content of a moving image, but may be applied to edition processing for a number of still images not formed as a moving image such as a number of still images obtained by continuous shooting.

In the present embodiment, the image editing apparatus 1 is achieved by the computer apparatus performing the image editing program, but various examples may be included as specific apparatuses. For example, the above-described edition processing may be achieved when the image editing program according to the embodiment of the present disclosure is performed by an image pick up apparatus such as a video camera or a digital still camera, an image reproduction apparatus, an image record apparatus, a game instrument, a video edition apparatus, PDA (Personal Digital Assistant), a mobile phone or other various apparatuses (or may be achieved by hardware) to obtain the processing functions as illustrated in FIG. 2 and FIG. 14.

Additionally, the present technology may also be configured as follows.

(1) An image editing program that causes an arithmetic processing unit to execute:

setting a recognition target image from an image included in image data as well as setting attribute information of the recognition target image;

searching a frame image for the recognition target image by using the attribute information with respect to each of frames constituting the image data; and

assigning image processing information regarding a processing target region determined in accordance with an image range, within a frame, of the recognition target image retrieved in the step of searching.

(2) The image editing program according to (1), wherein the processing target region determined in accordance with the image range of the retrieved recognition target image in the frame is a region of the image range of the recognition target image.

(3) The image editing program according to (1) or (2), further causing the arithmetic processing unit to execute, in the step of assigning, correcting the processing target region or the image processing information in accordance with input after assigning the image processing information to the processing target region in each of the frames.

(4) The image editing program according to (3),

wherein, in the steps of setting, searching, and assigning, each recognition target image which has been set is managed as a track distinguished from another track by the attribution information, and the processing target region and the image processing information are set for each track for each frame, and

wherein, in the step of correcting, the arithmetic processing unit is caused to perform, in accordance with input specifying a track, correction of the processing target region or the image processing information of the specified track.

(5) The image editing program according to (3) or (4),

wherein, in the steps of setting, searching, and assigning, each recognition target image which has been set is managed as a track distinguished from another track by the attribution information, and the processing target region and the image processing information are set for each track for each frame, and

wherein, in the step of correcting, the arithmetic processing unit is caused to perform, in accordance with input specifying a track and one or a plurality of frames, correction of the processing target region or the image processing information in the specified one or plurality of frames of the specified track.

(6) The image editing program according to any of (1) to (5), wherein, in the step of setting, the arithmetic processing unit is caused to execute automatically detecting a particular type of image from the image included in the image data, and setting the detected image as the recognition target image as well as setting the attribution information.

(7) The image editing program according to (6), wherein the particular type of image is a face image of a person, and personal identification information and search auxiliary information are set as the attribution information.

(8) The image editing program according to (7), wherein, in the step of searching, the arithmetic processing unit is caused to execute detecting the face image with respect to each of frames constituting the image data, and searching a frame image for the face image of a particular person that is the recognition target image by using the personal identification information and the search auxiliary information.

(9) The image editing program according to any of (1) to (8), wherein, in the step of setting, the arithmetic processing unit is caused to execute setting an image included in a range specified by input for the image included in the image data as the recognition target image, and setting at least the search auxiliary information as the attribution information.

(10) The image editing program according to any of (1) to (9), wherein input of a processing command supplied from an external device via a wired or wireless transmission channel is detected, and the arithmetic processing unit is caused to execute, in response to the input, processes of at least the step of setting, the step of searching, and the step of assigning.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-166243 filed in the Japan Patent Office on Jul. 29, 2011, the entire content of which is hereby incorporated by reference.

What is claimed is:

1. An image editing program that causes an arithmetic processing unit to execute:
setting a recognition target image from an image included in image data as well as setting attribute information of the recognition target image;
searching a frame image for the recognition target image by using the attribute information with respect to each of frames constituting the image data; and
assigning image processing information regarding a processing target region determined in accordance with an image range, within a frame, of the recognition target image retrieved in the step of searching.

2. The image editing program according to claim 1, wherein the processing target region determined in accordance with the image range of the retrieved recognition target image in the frame is a region of the image range of the recognition target image.

3. The image editing program according to claim 1, further causing the arithmetic processing unit to execute, in the step of assigning, correcting the processing target region or the image processing information in accordance with input after assigning the image processing information to the processing target region in each of the frames.

4. The image editing program according to claim 3,
wherein, in the steps of setting, searching, and assigning, each recognition target image which has been set is managed as a track distinguished from another track by the attribution information, and the processing target region and the image processing information are set for each track for each frame, and
wherein, in the step of correcting, the arithmetic processing unit is caused to perform, in accordance with input specifying a track, correction of the processing target region or the image processing information of the specified track.

5. The image editing program according to claim 3,
wherein, in the steps of setting, searching, and assigning, each recognition target image which has been set is managed as a track distinguished from another track by the attribution information, and the processing target region and the image processing information are set for each track for each frame, and
wherein, in the step of correcting, the arithmetic processing unit is caused to perform, in accordance with input specifying a track and one or a plurality of frames, correction of the processing target region or the image processing information in the specified one or plurality of frames of the specified track.

6. The image editing program according to claim 1, wherein, in the step of setting, the arithmetic processing unit is caused to execute automatically detecting a particular type of image from the image included in the image data, and setting the detected image as the recognition target image as well as setting the attribution information.

7. The image editing program according to claim 6, wherein the particular type of image is a face image of a person, and personal identification information and search auxiliary information are set as the attribution information.

8. The image editing program according to claim 7, wherein, in the step of searching, the arithmetic processing unit is caused to execute detecting the face image with respect to each of frames constituting the image data, and searching a frame image for the face image of a particular person that is the recognition target image by using the personal identification information and the search auxiliary information.

9. The image editing program according to claim 1, wherein, in the step of setting, the arithmetic processing unit is caused to execute setting an image included in a range specified by input for the image included in the image data as the recognition target image, and setting at least the search auxiliary information as the attribution information.

10. The image editing program according to claim 1, wherein input of a processing command supplied from an external device via a wired or wireless transmission channel is detected, and the arithmetic processing unit is caused to execute, in response to the input, processes of at least the step of setting, the step of searching, and the step of assigning.

11. An image editing method comprising:
setting a recognition target image from an image included in image data as well as setting attribute information of the recognition target image;
searching a frame image for the recognition target image by using the attribute information with respect to each of frames constituting the image data; and
assigning image processing information regarding a processing target region determined in accordance with an image range, within a frame, of the recognition target image retrieved in the step of searching.

12. An image editing apparatus comprising:
a setting processing part setting a recognition target image from an image included in image data as well as setting attribute information of the recognition target image;
a searching processing part searching a frame image for the recognition target image by using the attribute information with respect to each of frames constituting the image data; and
an image processing setting part assigning image processing information regarding a processing target region determined in accordance with an image range, within a frame, of the recognition target image retrieved by the searching processing part.

13. A storage medium storing an image editing program that causes an arithmetic processing unit to execute:
setting a recognition target image from an image included in image data as well as setting attribute information of the recognition target image;
searching a frame image for the recognition target image by using the attribute information with respect to each of frames constituting the image data; and
assigning image processing information regarding a processing target region determined in accordance with an image range, within a frame, of the recognition target image retrieved in the step of searching.
